(19) United States
(12) Patent Application Publication
(10) Pub. No.: US 2025/0156761 A1
(43) Pub. Date: May 15, 2025

(54) METHOD AND APPARATUS FOR PREPROCESSING LEARNING DATA FOR ARTIFICIAL INTELLIGENCE MODEL USING GENERALIZATION INDICES

(71) Applicant: Soojin KIM, Seoul (KR)

(72) Inventors: Soojin KIM, Seoul (KR); Sung Min KIM, Seoul (KR)

(21) Appl. No.: 18/943,353

(22) Filed: Nov. 11, 2024

(30) Foreign Application Priority Data
Nov. 13, 2023 (KR) 10-2023-0156760

(51) Int. Cl. G06N 20/00

(52) U.S. Cl. CPC G06N 20/00

(57) ABSTRACT

Proposed is a method for preprocessing learning data for an artificial intelligence model using generalization indices. The method may include collecting learning data for learning an artificial intelligence model, calculating generalization indices of the collected learning data, and preprocessing the collected learning data based on the calculated generalization indices. The method may include generating a plurality of groups, the plurality of groups respectively corresponding to generalization ranges determined based on the calculated generalization indices, and assigning the collected learning data to one of the plurality of groups based on the calculated generalization indices and generating a learning data set used for learning the artificial intelligence model by selecting at least one data from each group. A number of collected learning data selected from each group may be determined based on generalization indices of all of collected learning data assigned to the each group.

### CROSS REFERENCE TO RELATED APPLICATION

The present application claims priority to Korean Patent Application No. 10-2023-0156760, filed on Nov. 13, 2023, the entire contents of which is incorporated herein for all purposes by this reference.

### TECHNICAL FIELD

The present disclosure relates to a method and apparatus for preprocessing learning data for an artificial intelligence model using generalization indices.

### BACKGROUND

Machine learning, which plays an important role in the field of artificial intelligence, is a method that involves learning from data to build artificial intelligence models and making predictions on new data.

The performance of artificial intelligence may be improved through learning, and a variety of learning data may be required for the learning process. Particularly, as the amount of learning data used for learning increases, the performance of the artificial intelligence models may be enhanced.

### SUMMARY

One aspect is a method and apparatus for efficiently learning an artificial intelligence model with a small amount of learning data.

Another aspect is a method and apparatus that is capable of learning an artificial intelligence model by classifying reliable learning data.

However, aspects of the present disclosure are not limited to that mentioned above, and other aspects that are not mentioned may be clearly understood by those of ordinary skill in the art and may be included in the present disclosure.

Another aspect is a method for preprocessing learning data for an artificial intelligence model using generalization indices, which is performed by learning data-preprocessing apparatus, the method comprising, collecting learning data for learning an artificial intelligence model, calculating generalization indices of the collected learning data, preprocessing the collected learning data based on the calculated generalization indices, generating a plurality of groups, the plurality of groups respectively corresponding to generalization ranges determined based on the calculated generalization indices, assigning the collected learning data to one of the plurality of groups based on the calculated generalization indices and generating a learning data set used for learning the artificial intelligence model by selecting at least one data from each group, and a number of collected learning data selected from each group is determined based on generalization indices of all of collected learning data assigned to the each group.

The generalization indices may be calculated based on a popularity or reliability of the collected learning data.

The generalization indices may be calculated based on information related to the generalization indices, when the collected learning data is information included in a website, the information related to the generalization indices including at least one of quantified information such as generalization indices information on the website, generalization indices information on an owner of the website, creation date information, modification date information, view count information, download count information, and citation count information on the collected learning data.

The generalization indices may be calculated based on information related to the generalization indices, when the collected learning data is information included in a book, the information related to the generalization indices including at least one of quantified information such as generalization indices information on a publisher who published the book, generalization indices information on an author of the book, information on a date of publication of a first edition, information on a date of publication of a revised edition, citation count information, review processing count, information on number of copies published, information on number of copies sold, and revision count information.

The generalization indices may be calculated based on the information related to the generalization indices, when the collected learning data is information included in an article, the information related to the generalization indices including at least one of quantified information such as generalization indices information on a journal in which the article is published, generalization indices information on an author of the article, submission date information, publication date information, view count information on the article, number of reviewers of the article, download count information, and citation count information.

The generalization indices may be calculated based on information related to the generalization indices, when the collected learning data is information included in an output of the artificial intelligence model, the information related to the generalization indices including at least one of quantified information such as generalization indices information on the artificial intelligence model, generalization indices information on an owner of the artificial intelligence model, a time when the artificial intelligence model was made publicly available, a number of times the artificial intelligence model was used, a time when the artificial intelligence model was used, the number of regions the artificial intelligence model was used in, a number of times the artificial intelligence model was re-explored, and citation count information.

The generalization indices may be calculated by applying a weight to each assessment index calculated by the information related to the generalization indices.

The method may further comprise visually dividing and outputting the learning data set used for learning the artificial intelligence model classified based on the generalization indices.

The method may further comprise learning the artificial intelligence model using the classified learning data and outputting a result value using the learned artificial intelligence model, wherein the learning of the artificial intelligence model may include optimizing the weight based on a loss function used for learning the artificial intelligence model.

In the learning of the artificial intelligence model, data that does not have generalization indices of a preset or higher index among the classified learning data may be excluded, and residual learning data among the classified learning data may be used to learn the artificial intelligence model.

The generalization indices may be recalculated to reflect a contribution, the contribution being a degree to which the collected learning data has contributed to an output of the artificial intelligence model, and wherein the outputting of the result value may further include evaluating the contribution of the collected learning data to the outputted result value, outputting the contribution and feeding the contribution of the collected learning data back to a source of the collected learning data.

The method may further comprise recalculating generalization indices of the preprocessed learning data used in learning of the artificial intelligence model in consideration of the contribution and preprocessing the preprocessed learning data by reflecting the recalculated generalization indices.

In the outputting of the result value, the result value may be output visually different using at least one of highlighting, changing a text thickness, and changing a text color according to the generalization indices.

In the outputting of the result value, the generalization indices of the collected learning data may be further displayed separately.

In the outputting of the result value, source information on the collected learning data may be further displayed separately.

The preprocessing may be embedding the generalization indices into the collected learning data.

The method may further comprise assigning the collected learning data to one of the plurality of groups based on the calculated generalization indices of a source of the collected learning data.

Another aspect is an apparatus for preprocessing learning data for an artificial intelligence model using generalization indices, the apparatus comprising, at least one memory capable of storing computer-executable instructions and a processor configured to, by executing the instructions, collect learning data for learning an artificial intelligence model, calculate generalization indices of the collected learning data, preprocess the collected learning data based on the calculated generalization indices, generate a plurality of groups, the plurality of groups respectively corresponding to generalization ranges determined based on the calculated generalization indices, assign the collected learning data to one of the plurality of groups based on the calculated generalization indices and generate a learning data set used for learning the artificial intelligence model by selecting at least one data from each group, and a number of collected learning data selected from each group is determined based on generalization indices of all of collected learning data assigned to the each group.

Another aspect is a non-transitory computer-readable storage medium storing computer-executable instructions, the computer executable instructions, when executed by a processor, allowing the processor to perform a method, the method comprising, collecting learning data for learning an artificial intelligence model, calculating generalization indices of the collected learning data, preprocessing the collected learning data based on the calculated generalization indices, generating a plurality of groups, the plurality of groups respectively corresponding to generalization ranges determined based on the calculated generalization indices, assigning the collected learning data to one of the plurality of groups based on the calculated generalization indices and generating a learning data set used for learning the artificial intelligence model by selecting at least one data from each group, and a number of collected learning data selected from each group is determined based on generalization indices of all of collected learning data assigned to the each group.

According to the present disclosure, by preprocessing generalization indices, including source information and the like, in learning data of an artificial intelligence model, data with a high generalization indices can be prioritized for learning the artificial intelligence model.

In addition, since more generalized information from a large amount of learning data is used for learning of the artificial intelligence model, the artificial intelligence model can be learned efficiently even with a small amount of learning data.

In addition, data that is not generalized, classified by a preprocessing method using generalization indices, can be excluded from the learning data.

In addition, learning data within a predetermined range of the generalization indices can be classified and used for learning.

### BRIEF DESCRIPTION OF THE DRAWINGS

FIG. 1 is a flowchart exemplarily illustrating a method for preprocessing learning data for an artificial intelligence model using generalization indices according to a first aspect of the present disclosure.

FIG. 2 is a block diagram exemplarily illustrating an apparatus for preprocessing learning data for an artificial intelligence model using generalization indices according to a second aspect of the present disclosure.

FIG. 3 is a block diagram exemplarily illustrating a function of a program for preprocessing learning data for an artificial intelligence model using generalization indices.

FIG. 4 is an exemplified view of data preprocessing for numerical standardization or bias in learning data.

FIG. 5 is an exemplified view illustrating a use of generalization indices according to the present disclosure for preprocessing learning data.

FIG. 6 is an exemplified view illustrating a use of generalization indices according to the present disclosure for learning an artificial intelligence model.

### DETAILED DESCRIPTION

Currently, when extracting features during the preprocessing of learning data for artificial intelligence models, the decision on which features to extract is typically made based on human experience. In addition, the features that can well reflect the goals to be inferred by artificial intelligence models need to be extracted to generate high-quality learning data, ensuring the successful development of the models. Therefore, the process of collecting learning data and performing data preprocessing to obtain high-quality learning data for learning of an artificial intelligence model can be considered the most resource-intensive part of AI model development.

However, as described above, a large amount of learning data is required to ensure the performance of artificial intelligence models, but it is difficult to secure high-quality learning data in large quantities.

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

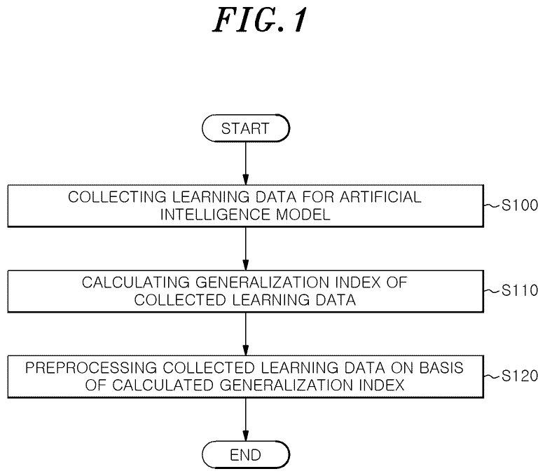

FIG. 1 is a flowchart exemplarily illustrating A method for preprocessing learning data for an artificial intelligence model using generalization indices according to a first aspect of the present disclosure.

Hereinafter, A method for preprocessing learning data for an artificial intelligence model using generalization indices will be described on the premise that the method is performed by an apparatus for preprocessing learning data.

As illustrated in FIG. 1, A method for preprocessing learning data for an artificial intelligence model using generalization indices according to a first aspect of the present disclosure includes collecting learning data for learning of an artificial intelligence model (S100), calculating generalization indices of the collected learning data (S110), and preprocessing the collected learning data based on the calculated generalization indices (S120).

The generalization indices may be calculated based on the popularity or reliability of the learning data. For example, as the content of the collected learning data is more popular among the public, the generalization indices may be calculated higher. In addition, the generalization indices may be calculated based on the popularity or reliability of a source of learning data. For example, the generalization indices may be calculated to be high when the content of the collected learning data has a high probability of being true, or is generated from a highly reliable source. In contrast, the generalization indices may be calculated to be low when the content of the collected learning data is false, or comes from a source with no or low reliable information. An assessment of the popularity, factuality, reliability, reliability of the source of the collected learning data, or the like, may be performed specifically as described below.

The generalization indices may be calculated based on information related to the generalization indices, when the collected learning data is information included in a website, the information related to the generalization indices including at least one of generalization indices information on the website, generalization indices information on an owner of the website, or quantified information such as creation date information, modification date information, view count information, download count information, and citation count information on the collected learning data. Here, the generalization indices may be calculated in consideration of the popularity or reliability of the source of the collected learning data, through the generalization indices information on the website and the generalization indices information on the owner of the website. In addition, the generalization indices may be calculated by applying a weight to each assessment index calculated for each quantified information.

The generalization indices may be calculated based on information related to the generalization indices, when the learning data is information included in a book, the information related to the generalization indices including at least one of quantified information such as generalization indices information on a publisher who published the book, generalization indices information on an author of the book, information on a date of publication of a first edition, information on a date of publication of a revised edition, citation count information, review processing count, information on number of copies published, information on number of copies sold, and revision count information. Here, the generalization indices may be calculated in consideration of the popularity or reliability of the source of the collected learning data, through the generalization indices information on a publisher who published the book and the generalization indices information on an author of the book. In addition, the generalization indices may be calculated by applying a weight to each assessment index calculated for each quantified information.

The generalization indices may be calculated, when the learning data is information included in an article, based on the information that includes at least one of generalization indices information on a journal in which the article is published, generalization indices information on an author of the article, or quantified information such as submission date information, publication date information, view count information on the article, number of reviewers of the article, download count information, and citation count information. Here, the generalization indices may be calculated in consideration of the popularity or reliability of the source of the collected learning data, through the generalization indices information on a journal in which the article is published and the generalization indices information on an author of the article. In addition, the generalization indices may be calculated by applying a weight to each assessment index calculated for each quantified information.

The generalization indices may be calculated based on information related to the generalization indices, when the collected learning data is information included in an output of the artificial intelligence model, the information related to the generalization indices including at least one of generalization indices information on the artificial intelligence model, generalization indices information on an owner of the artificial intelligence model, or quantified information such as a time when the artificial intelligence model was made publicly available, a number of times the artificial intelligence model was used, a time when the artificial intelligence model was used, the number of regions the artificial intelligence model was used in, a number of times the artificial intelligence model was re-explored, and citation count information. In addition, the generalization indices may be calculated by applying a weight to each assessment index calculated for each quantified information.

The generalization indices may be calculated based on information including at least one of quantified information such as creation date information, modification date information, view count information, download count information, and citation count information on the collected learning data, regardless of the source, when the learning data relates to a proper noun (e.g., a natural law, a formula, an invention, etc.). A criterion for determining whether the collected learning data is a proper name may be input by a user.

The generalization indices may be calculated based on quantified information that reflects the countable popularity or reliability of the source of the collected learning data.

The generalization indices may be recalculated to reflect a contribution, which is a degree to which the learning data contributed to an output of the artificial intelligence model. In addition, the generalization indices of the preprocessed learning data used for learning of the artificial intelligence model may be recalculated in consideration of the contribution. In this case, the previously preprocessed learning data may be preprocessed again to reflect the recalculated generalization indices.

Preprocessing the learning data may refer to processing a dataset into a suitable form prior to the learning of the artificial intelligence model. For example, the preprocessing of the learning data may refer to embedding the generalization indices into the collected learning data. Through the preprocessing procedure, the learning data may include generalization indices or source information for the learning data.

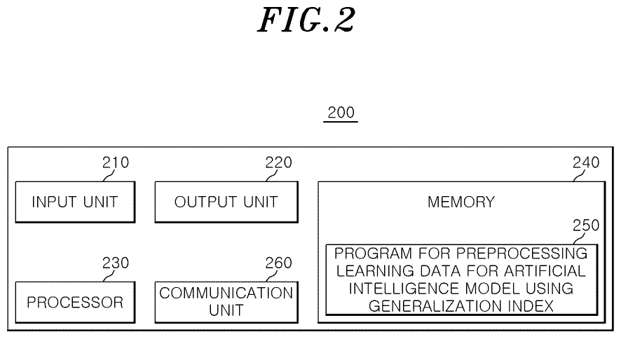

FIG. 2 is a block diagram exemplarily illustrating an apparatus for preprocessing learning data for an artificial intelligence model using generalization indices according to a first aspect of the present disclosure.

As illustrated in FIG. 2, an apparatus 200 for preprocessing learning data for an artificial intelligence model using generalization indices may include an input unit 210, an output unit 220, a processor 230, a memory 240, and a communication unit 260.

The input unit 210 may receive commands, information, and the like used to control the apparatus 200 for preprocessing learning data for an artificial intelligence model using generalization indices directly through a user interface (e.g., keyboard, touch input, etc.).

In an embodiment, the input unit 210 may receive information necessary for calculating the generalization indices and information necessary for preprocessing the learning data from the user.

In another embodiment, the input unit 210 may receive a criterion for generalization indices required for classification or selection of the learning data from the user.

The output unit 220 may display information including information necessary for calculating the generalization indices, information necessary for preprocessing the learning data, the collected learning data, the generalization indices of the learning data, the preprocessed learning data, an output result value of the learned artificial intelligence model, source information on the learning data, and the like as visual information through an interface or display means.

The processor 230 may control an overall operation of the apparatus 200 for preprocessing learning data for an artificial intelligence model using generalization indices to perform the present disclosure.

To execute a program 250 for preprocessing learning data for an artificial intelligence model using generalization indices, the processor 230 may load the program 250 for preprocessing learning data for an artificial intelligence model using generalization indices and information necessary for execution of the program 250 for preprocessing learning data for an artificial intelligence model using generalization indices from the memory 240.

The processor 230 may control data received from an external device through the communication unit 260 to be stored in the memory 240. The processor 230 may control such that information including information necessary for calculating the generalization indices, information necessary for preprocessing the learning data, the collected learning data, the generalization indices of the learning data, the preprocessed learning data, an output result value of the learned artificial intelligence model, source information on the learning data, and the like is transmitted to the outside through the communication unit 260.

Processor 230 may refer to a processing device such as a microprocessor, a central processing unit (CPU), a graphic processing unit (GPU), a processor core, a multiprocessor, an application-specific integrated circuit (ASIC), a field programmable gate array (FPGA), a microcontroller unit (MCU), and the like, but is not limited to the embodiments described above.

The memory 240 may store the program 250 for preprocessing learning data for an artificial intelligence model using generalization indices and information necessary for execution of the program 250 for preprocessing learning data for an artificial intelligence model using generalization indices. In addition, the memory 240 may store a processing result by the processor 230.

The program 250 for preprocessing learning data for an artificial intelligence model using generalization indices may refer to software that includes instructions programmed to perform a learning data preprocessing task.

The memory 240 may store information including information necessary for calculating the generalization indices, information necessary for preprocessing the learning data, the collected learning data, the generalization indices of the learning data, the preprocessed learning data, an output result value of the learned artificial intelligence model, source information on the learning data, and the like. In addition, the memory 240 may store information received from an external device through the communication unit 260.

The memory 240 may refer to a non-transitory computer-readable storage medium, such as magnetic media, such as a hard disk, a floppy disk, and magnetic tape, optical media, such as a CD-ROM or DVD, magneto-optical media, such as a floptical disk, a hardware device specifically configured to store and execute program instructions, such as flash memory, but is not limited to the embodiments described above.

The communication unit 260 may be a wireless communication module capable of performing wireless communication by adopting a communication method such as CDMA, GSM, W-CDMA, TD-SCDMA, WiBro, LTE, EPC, wireless lan, Wi-Fi, Bluetooth, zigbee, Wi-Fi direct (WFD), ultra wide band (UWB), infrared data association (IrDA), Bluetooth low energy (BLE), or near field communication (NFC), but is not limited to the embodiments described above.

In addition, information input and output through the input unit 210 and the output unit 220, information stored in the memory 240, and information transmitted and received through the communication unit 260 include all information related to the present disclosure, and are not limited to the embodiments described above.

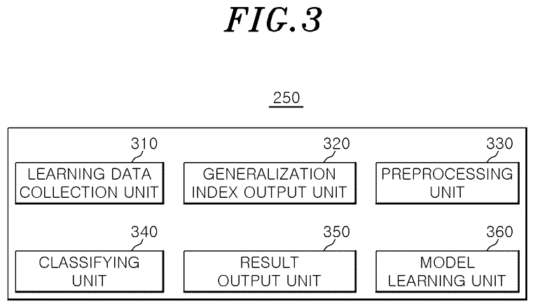

A function or operation of the program 250 for preprocessing learning data for an artificial intelligence model using generalization indices will be described in detail through FIG. 3.

FIG. 3 is a block diagram exemplarily illustrating a function of a program for preprocessing learning data for an artificial intelligence model using generalization indices.

As illustrated in FIG. 3, the program 250 for preprocessing learning data for an artificial intelligence model using generalization indices may include a learning data collection unit 310, generalization indices output unit 320, a preprocessing unit 330, a classifying unit 340, a result output unit 350, and a model learning unit 360. The learning data collection unit 310, the generalization indices output unit 320, the preprocessing unit 330, the classifying unit 340, the result output unit 350, and the model learning unit 360 are exemplary divisions of functions of the program 250 for preprocessing learning data for an artificial intelligence model using generalization indices, but these divisions are not limited thereto.

According to embodiments, the function of each of the learning data collection unit 310, the generalization indices output unit 320, the preprocessing unit 330, the classifying unit 340, the result output unit 350, and the model learning unit 360 may be mergeable/separable and implemented as a series of instructions included in one program.

The learning data collection unit 310, the generalization indices output unit 320, the preprocessing unit 330, the classifying unit 340, the result output unit 350, and the model learning unit 360 may be implemented by the processor 230 and may refer to data processing devices embedded in hardware, having physically structured circuitry to perform functions expressed by codes or instructions contained within the program 250 for preprocessing learning data for an artificial intelligence model using generalization indices stored in the memory 240.

The learning data collection unit 310 may collect learning data for learning of the artificial intelligence model.

The learning data collection unit 310 may receive learning data for the artificial intelligence model directly from an external device. In addition, the learning data collection unit 310 may receive learning data for the artificial intelligence model through the communication unit 260.

The generalization indices output unit 320 may calculate generalization indices of the learning data collected by the learning data collection unit 310.

The generalization indices may be calculated based on the popularity or reliability of the learning data. For example, as the content of the collected learning data is more popular among the public, the generalization indices may be calculated higher. In addition, the generalization indices may be calculated based on the popularity or reliability of a source of learning data. For example, the generalization indices may be calculated to be high when the content of the collected learning data has a high probability of being true, or is generated from a highly reliable source. In contrast, the generalization indices may be calculated to be low when the content of the collected learning data is false, or comes from a source with no or low reliable information. In addition, the generalization indices may be calculated by applying a weight to each assessment index calculated for each piece of information used to calculate the generalization indices.

The preprocessing unit 330 may preprocess the learned data collected based on the generalization indices calculated by the generalization indices output unit 320. In addition, the preprocessing unit 330 may embed the generalization indices into the collected learning data.

Preprocessing the learning data may refer to processing a dataset into a suitable form prior to the learning of the artificial intelligence model. For example, the preprocessing of the learning data may refer to embedding the generalization indices into the collected learning data. Through the preprocessing process, the learning data may include generalization indices or source information.

The classifying unit 340 may classify the learning data used for learning of the artificial intelligence model based on the generalization indices preprocessed on the learning data by the preprocessing unit 330. For example, the classifying unit 340 may determine one or more generalization indices ranges to classify multiple learning data into one or more groups based on whether generalization indices preprocessed on the multiple learning data falls within the determined generalization indices range.

When the learning data is classified through the classifying unit 340, personal information, unfounded information, and information on a specific minority group may be excluded from the learning data for learning of the artificial intelligence model. In addition, once the learning data is classified through the classifying unit 340, the learning data may be applied as a classification condition to identify the features that information shared only within a specific minority group has (e.g., criminal information, rare diseases, unethical information, etc.). In addition, once the learning data is classified through the classifying unit 340, the generalization indices of a predetermined range may be applied as a classification condition to identify features of a case in which the data is exposed only to specific tendencies or information on a predetermined generalization indices.

The result output unit 350 may output a result value using the artificial intelligence model learned by the model learning unit 360.

In outputting a result value, the result output unit 350 may assess the contribution of the learning data to the output result value and output the assessed contribution. In addition, the result output unit 350 may feedback the contribution of the learning data to the source of the learning data through the communication unit 260. The generalization indices output unit 320 may recalculate generalization indices of the preprocessed learning data used for learning of the artificial intelligence model in consideration of the contribution assessed by the result output unit 350. In this case, the preprocessing unit 330 may preprocess the preprocessed learning data again to reflect the generalization indices recalculated by the generalization indices output unit 320.

The result output unit 350 may visually divide and output the learning data used for learning of the artificial intelligence model classified by the classifying unit 340 based on the generalization indices. More specifically, the result output unit 350 may output the learning data visually differently using at least one of highlighting, changing a text thickness, and changing a text color according to the generalization indices.

The user may more easily identify information on the generalization indices and corresponding learning data that is output visually different by the result output unit 350.

The result output unit 350 may further display generalization indices of the collected learning data separately.

The result output unit 350 may further display source information on the collected learning data separately. In this case, the source information may be input from an owner of the source of the collected learning data.

The model learning unit 360 may learn the artificial intelligence model using the learning data classified by the classifying unit 340.

The model learning unit 360 may optimize the weight based on a loss function used for learning of the artificial intelligence model. In this case, the weight may be applied to an assessment index for one or more pieces of information considered in calculating the generalization indices. In contrast, the weight may be input directly through the input unit 210.

The model learning unit 360 may select a specific group of the learning data classified by the classifying unit 340 based on the generalization indices and use the specific group for the learning data. For example, the model learning unit 360 may exclude learning data that does not have generalization indices of a preset index or higher among the learning data classified by the classifying unit 340, and use only residual learning data to learn the artificial intelligence model.

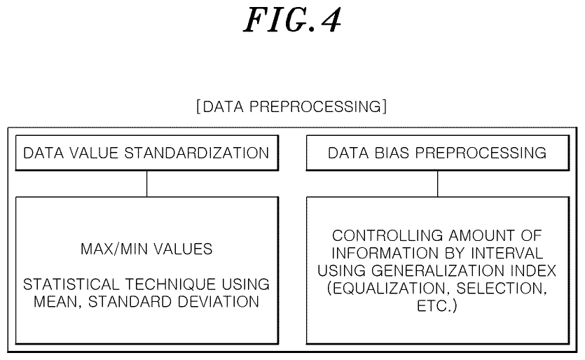

FIG. 4 is an exemplified view of data preprocessing for numerical standardization or bias in learning data.

As illustrated in FIG. 4, in the method of preprocessing learning data for an artificial intelligence model using generalization indices according to the present disclosure, the generalization indices may be calculated by standardizing the numerical values of each piece of information used to calculate the generalization indices. As an example of using a creation date of the collected learning data in calculating the generalization indices, when a creation date of data A is 90 days earlier than a creation date of data B, the assessment index for the creation date may be 90 for A and 0 for B. In this case, methods such as min-max normalization may be used for standardization with other information used to calculate the generalization indices. For another example, the number of times the collected learning data has been viewed, the number of times the collected data has been downloaded, the number of times the collected data has been cited, and the like may be identified, and then the identified respective number of times may be normalized to calculate an assessment index for each piece of information.

Each assessment index calculated for each piece of information used to calculate the generalization indices may be calculated as one generalization indices through calculations such as sums and products. In addition, each assessment index may be weighted to calculate generalization indices.

As illustrated in FIG. 4, in the method of preprocessing learning data for an artificial intelligence model using generalization indices according to the present disclosure, an amount of learning data used for learning the model may be adjusted using the calculated generalization indices. By calculating not only the generalization indices of the learning data itself, but also the generalization indices of the source of the learning data, the amount of learning data used for learning of the model may be adjusted through the calculated generalization indices of the source of the learning data. In this case, the generalization indices for the source may be calculated through methods such as adding each generalization indices of the learning data generated from the source, or normalizing. In addition, the method of adjusting the amount of learning data used for learning the model may be to adjust the amount of learning data in proportion to the calculated generalization indices.

For example, when there is a group A of learning data with generalization indices of 1 and a group B of learning data with generalization indices of 9, a ratio of learning data in learning the model may be determined as group A:group B=1:9. Here, generalization indices of group including learning data may be determined as the average or summation of a plurality of generalization indices corresponding to each of a plurality of learning data included within the same group. Accordingly, the ratio of the amount of learning data in the group A of learning data and the group B of learning data is determined to be 1:9, and the learning data of the model may be generated and the model may be learned. That is, the amount of data used for learning may be selected to be proportional to the generalization indices. In order to prevent a bias in the amount of data when the learning data is selected by dividing a range of the entire generalization indices into n intervals, an amount of data for each interval may be adjusted as shown in Equation 1.

$$Amount of {data}_{total} = Amount of {data}_{interval 1} + Amount of {data}_{interval 2} + … + Amount of {data}_{interval n} \qquad Equation 1$$

$$\frac{Amount of {data}_{interval 1}}{Generalization {index}_{interval 1}} = \frac{Amount of {data}_{interval 2}}{Generalization {index}_{interval 2}} = … = \frac{Amount of {data}_{interval n}}{Generalization {index}_{interval n}}$$

In addition, as shown in Equation 2, the ratio of the amount of data in each interval may be adjusted by adjusting a₁, a₂, . . . , aₙ for special purposes.

$${a}_{1} \frac{Amount of {data}_{interval 1}}{Generalization {index}_{interval 1}} = {a}_{2} \frac{Amount of {data}_{interval 2}}{Generalization {index}_{interval 2}} = … = {a}_{n} \frac{Amount of {data}_{interval n}}{Generalization {index}_{interval n}} \qquad Equation 2$$

The range of generalization indices for setting the interval may be adjusted depending on the user's purpose. In this case, data whose generalization indices are equal to or less than a predetermined value may be considered as information of private nature, such as personal information, and may be excluded from the learning data.

In addition, when n-dimensional data are measured to be identical or similar because the data are positioned very close to each other in a dimensional space, the generalization indices may be a criterion for selecting learning data. Among the identical or similar information, data with generalization indices equal to or greater than a specific value may be selected, data with a greatest generalization indices may be selected, data within a predetermined range may be selected, or data equal to or less than a predetermined value may be selected. For another example, when generalization indices of source A is 1 and generalization indices of source B is 9, in learning the model, a ratio of learning data generated from source A to learning data generated from source B may be determined to be 1:9, and the learning data of the model may be generated by selecting learning data from source A in the ratio of 1 and learning data from source B in the ratio of 9, and then the model may be learned.

That is, the data used for learning may be selected in proportion to the generalization indices of the source of the data used for learning. An amount of learning data selected by a range of the generalization indices of the source of the learning data may be expressed as shown in Equation 3.

$$\frac{Amount of {data}_{source 1}}{Generalization {index}_{source 1}} = \frac{Amount of {data}_{source 2}}{Generalization {index}_{source 2}} = … = \frac{Amount of {data}_{source n}}{Generalization {index}_{source n}} \qquad Equation 3$$

As shown in Equation 3, the problem of bias in the amount of data may be improved by adjusting the amount of data collected using the generalization indices of the source of the learning data. In addition, although Equation 3 expresses that a ratio of an amount of data to generalization indices for each source is identical, it is possible for the ratio of an amount of data to generalization indices for each source to differ within a preset tolerance range.

In addition, as shown in Equation 4, the ratio of the amount of data for each source may be adjusted by adjusting a₁, a₂, . . . , aₙ for special purposes.

$${a}_{1} \frac{Amount of {data}_{source 1}}{Generalization {index}_{source 1}} = {a}_{2} \frac{Amount of {data}_{source 2}}{Generalization {index}_{source 2}} = … = {a}_{n} \frac{Amount of {data}_{source n}}{Generalization {index}_{source n}} \qquad Equation 4$$

In this case, when the learning data is related to a proper noun, the learning data of the model may be generated and the model may be learned in consideration of only the generalization indices of the corresponding learning data and not in consideration of the generalization indices of the source.

In adjusting the amount of learning data in FIG. 4, the ratio of learning data using the generalization indices may be arbitrarily modified by the user. In addition, depending on the purpose, the learning data may be selected by weighting a specific generalization indices.

As an example of using the generalization indices to classify or equalize the learning data, it is possible to select the learning data using only one of the classification and equalization methods, and it is also possible to select the learning data using both.

Through the preprocessing process for bias in learning data using the generalization indices as above, the impact of incorrect or inaccurate learning data on the artificial intelligence model may be reduced.

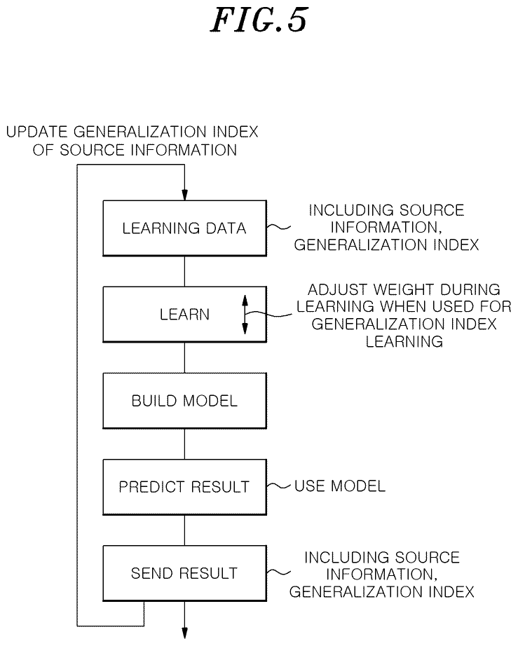

FIG. 5 is an exemplified view illustrating a use of generalization indices according to the present disclosure for preprocessing learning data.

When the model learned based on the collected learning data outputs a result, each learning data contribution to the result may affect the generalization indices for the corresponding learning data. Specifically, the generalization indices of the learning data may be recalculated to reflect a contribution, which is a degree to which the learning data has contributed to an output of the artificial intelligence model, and the calculated contribution of the learning data may be fed back to the source of the learning data or the generalization indices of the corresponding learning data in the collected learning dataset may be updated. Accordingly, the generalization indices of the preprocessed learning data used for learning of the artificial intelligence model may be recalculated in consideration of the contribution, and the preprocessed learning data may be preprocessed again by reflecting the recalculated generalization indices.

In addition, when other artificial intelligence models that are learned based on the collected learning data output results in addition to the output of the corresponding artificial intelligence model, when each learning data contributes to the result, the generalization indices of the corresponding artificial intelligence model may be recalculated by reflecting the contributions from other artificial intelligence models.

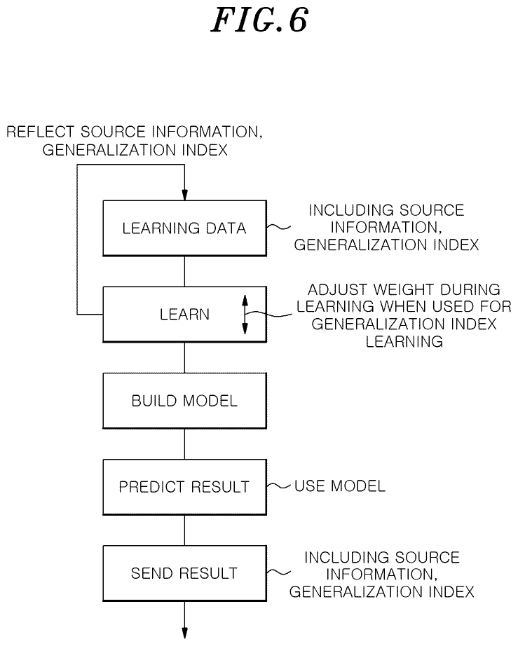

FIG. 6 is an exemplified view illustrating a use of generalization indices according to the present disclosure for learning an artificial intelligence model.

The generalization indices may be calculated by applying a weight and a predetermined coefficient as shown in Equation 5 to the calculated assessment index for each piece of information used to calculate the generalization indices.

$$generalization index = A * \sum {w}_{i} * {x}_{i} \qquad Equation 5$$

Here, A is an arbitrary constant, w is a weight applied to each piece of information used to calculate generalization indices, and x is an assessment index calculated for each piece of information used to calculate generalization indices. A may be a constant that is determined by a source of the corresponding learning data. For example, constant A may be determined to be large in case of learning data generated from a journal of an article with high popularity, and small in case of learning data generated from a personal blog. Accordingly, during the learning process of the model, w, which is a weight applied to each piece of information used to calculate the generalization indices, may be adjusted to calculate the generalization indices.

According to the present disclosure, as the generalization indices including source information and the like is preprocessed in the learning data of the artificial intelligence model, data having a high generalization indices may be prioritized for learning the artificial intelligence model. Therefore, the artificial intelligence model may be efficiently learned even with a small amount of learning data.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or non-transitory computer-readable storage medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A method for preprocessing learning data for an artificial intelligence model using generalization indices, which is performed by learning data-preprocessing apparatus, the method comprising:
collecting learning data for learning an artificial intelligence model;
calculating generalization indices of the collected learning data;
preprocessing the collected learning data based on the calculated generalization indices;
generating a plurality of groups, the plurality of groups respectively corresponding to generalization ranges determined based on the calculated generalization indices;
assigning the collected learning data to one of the plurality of groups based on the calculated generalization indices; and
generating a learning data set used for learning the artificial intelligence model by selecting at least one data from each group, and a number of collected learning data selected from each group is determined based on generalization indices of all of collected learning data assigned to the each group.

2. The method of claim 1, wherein the generalization indices are calculated based on a popularity or reliability of the collected learning data.

3. The method of claim 1, wherein the generalization indices are calculated based on information related to the generalization indices, when the collected learning data is information included in a website, the information related to the generalization indices including at least one of quantified information such as generalization indices information on the website, generalization indices information on an owner of the website, creation date information, modification date information, view count information, download count information, and citation count information on the collected learning data.

4. The method of claim 1, wherein the generalization indices are calculated based on information related to the generalization indices, when the collected learning data is information included in a book, the information related to the generalization indices including at least one of quantified information such as generalization indices information on a publisher who published the book, generalization indices information on an author of the book, information on a date of publication of a first edition, information on a date of publication of a revised edition, citation count information, review processing count, information on number of copies published, information on number of copies sold, and revision count information.

5. The method of claim 1, wherein the generalization indices are calculated based on the information related to the generalization indices, when the collected learning data is information included in an article, the information related to the generalization indices including at least one of quantified information such as generalization indices information on a journal in which the article is published, generalization indices information on an author of the article, submission date information, publication date information, view count information on the article, number of reviewers of the article, download count information, and citation count information.

6. The method of claim 1, wherein the generalization indices are calculated based on information related to the generalization indices, when the collected learning data is information included in an output of the artificial intelligence model, the information related to the generalization indices including at least one of quantified information such as generalization indices information on the artificial intelligence model, generalization indices information on an owner of the artificial intelligence model, a time when the artificial intelligence model was made publicly available, a number of times the artificial intelligence model was used, a time when the artificial intelligence model was used, the number of regions the artificial intelligence model was used in, a number of times the artificial intelligence model was re-explored, and citation count information.

7. The method of claim 3, wherein the generalization indices are calculated by applying a weight to each assessment index calculated by the information related to the generalization indices.

8. The method of claim 7, further comprising:
visually dividing and outputting the learning data set used for learning the artificial intelligence model classified based on the generalization indices.

9. The method of claim 7, further comprising:
learning the artificial intelligence model using the classified learning data; and
outputting a result value using the learned artificial intelligence model,
wherein the learning of the artificial intelligence model includes optimizing the weight based on a loss function used for learning the artificial intelligence model.

10. The method of claim 7, wherein, in learning the artificial intelligence model, data that does not have generalization indices of a preset or higher index among the classified learning data is excluded, and residual learning data among the classified learning data is used to learn the artificial intelligence model.

11. The method of claim 9, wherein the generalization indices are recalculated to reflect a contribution, the contribution being a degree to which the collected learning data has contributed to an output of the artificial intelligence model, and
wherein outputting the result value further includes:
evaluating the contribution of the collected learning data to the outputted result value;
outputting the contribution; and
feeding the contribution of the collected learning data back to a source of the collected learning data.

12. The method of claim 11, further comprising:
recalculating generalization indices of the preprocessed learning data used in learning of the artificial intelligence model in consideration of the contribution; and
preprocessing the preprocessed learning data by reflecting the recalculated generalization indices.

13. The method of claim 12, wherein in outputting the result value, the result value is output visually different using at least one of highlighting, changing a text thickness, and changing a text color according to the generalization indices.

14. The method of claim 11, wherein in outputting the result value, the generalization indices of the collected learning data is further displayed separately.

15. The method of claim 14, wherein in outputting the result value, source information on the collected learning data is further displayed separately.

16. The method of claim 1, wherein the preprocessing is embedding the generalization indices into the collected learning data.

17. The method of claim 1, further comprising:
assigning the collected learning data to one of the plurality of groups based on the calculated generalization indices of a source of the collected learning data.

18. An apparatus for preprocessing learning data for an artificial intelligence model using generalization indices, the apparatus comprising:
at least one memory capable of storing computer-executable instructions; and
a processor configured execute the instructions to:
collect learning data for learning an artificial intelligence model;
calculate generalization indices of the collected learning data;
preprocess the collected learning data based on the calculated generalization indices;
generate a plurality of groups, the plurality of groups respectively corresponding to generalization ranges determined based on the calculated generalization indices;
assign the collected learning data to one of the plurality of groups based on the calculated generalization indices; and
generate a learning data set used for learning the artificial intelligence model by selecting at least one data from each group, and a number of collected learning data selected from each group is determined based on generalization indices of all of collected learning data assigned to the each group.

19. A non-transitory computer-readable storage medium storing computer-executable instructions, when executed by one or more processors, causing the one or more processors to perform the method of claim 1.
